(19) United States
(12) Patent Application Publication
(10) Pub. No.: US 2022/0197989 A1
(43) Pub. Date: Jun. 23, 2022

(54) GAMIFICATION-BASED MULTI-FACTOR AUTHENTICATION

(71) Applicant: International Business Machines Corporation, Armonk, NY (US)

(72) Inventor: Sarbajit K. Rakshit, Kolkata (IN)

(21) Appl. No.: 17/128,318

(22) Filed: Dec. 21, 2020

(51) Int. Cl. G06F 21/36; G06F 3/01; G06T 19/00

(52) U.S. Cl. CPC G06F 21/36; G06T 19/006; G06F 3/017; G06F 3/011

(57) ABSTRACT

A method, system, and computer program product for gamification of multi-factor authentication are provided. The method receives an authentication request for a user. An application context is identified for the authentication request. A set of input devices are identified which are associated with an authentication system. Based on the application context and the set of input devices, a set of user interaction prompts are generated for the authorization request. The set of user interaction prompts correspond to one or more user interactions with one or more input devices. The set of user interaction prompts are presented within an audio-visual environment. Authentication data is captured from the one or more input devices during presentation of the set of user interaction prompts. The method authenticates the user based on the authentication data.

### BACKGROUND

Authentication processes are used to recognize a user's identity within a computing system, network, or device. Authentication processes often include an incoming request and set of identifying credentials. The credentials are often supplied by a user attempting to access the computing system, network, or device. The system, network, or device often compares the set of identifying credentials with sets of credentials stored within a database and associated with authorized users of the system, network, or device. Once the identifying credentials are matched to an existing set of credentials, the user is allowed access to at least some resources of the system, network, or device.

Authentication processes have increased in complexity as threats and vulnerabilities have been revealed within computing resources. Single factor authentication or primary authentication uses a single authentication method to verify a user's identity. Single factor authentication credentials may include a password, security pin, personal identity verification (PIV) card, or another credential possessed by a user. Two-factor authentication uses two pieces of identifying credentials to verify a user's identity. Some two-factor authentication systems use tokens generated by a registered computing device, one-time passwords, pin numbers, or other generated or transmitted credentials in conjunction with a primary credential, such as those used in single factor authentication. Multi-factor authentication uses two or more independent factors or identifying credentials.

### SUMMARY

According to an embodiment described herein, a computer-implemented method for gamification of multi-factor authentication is provided. The method receives an authentication request for a user. An application context is identified for the authentication request. A set of input devices are identified which are associated with an authentication system. Based on the application context and the set of input devices, a set of user interaction prompts are generated for the authorization request. The set of user interaction prompts correspond to one or more user interactions with one or more input devices. The set of user interaction prompts are presented within an audio-visual environment. Authentication data is captured from the one or more input devices during presentation of the set of user interaction prompts. The method authenticates the user based on the authentication data.

According to an embodiment described herein, a system for gamification of multi-factor authentication is provided is provided. The system includes one or more processors and a computer-readable storage medium, coupled to the one or more processors, storing program instructions that, when executed by the one or more processors, cause the one or more processors to perform operations. The operations receive an authentication request for a user. An application context is identified for the authentication request. A set of input devices are identified which are associated with an authentication system. Based on the application context and the set of input devices, a set of user interaction prompts are generated for the authorization request. The set of user interaction prompts correspond to one or more user interactions with one or more input devices. The set of user interaction prompts are presented within an audio-visual environment. Authentication data is captured from the one or more input devices during presentation of the set of user interaction prompts. The operations authenticate the user based on the authentication data.

According to an embodiment described herein, a computer program product for gamification of multi-factor authentication is provided. The computer program product includes a computer-readable storage medium having program instructions embodied therewith, the program instructions being executable by one or more processors to cause the one or more processors to receive an authentication request for a user. An application context is identified for the authentication request. A set of input devices are identified which are associated with an authentication system. Based on the application context and the set of input devices, a set of user interaction prompts are generated for the authorization request. The set of user interaction prompts correspond to one or more user interactions with one or more input devices. The set of user interaction prompts are presented within an audio-visual environment. Authentication data is captured from the one or more input devices during presentation of the set of user interaction prompts. The computer program product authenticates the user based on the authentication data.

### BRIEF DESCRIPTION OF THE DRAWINGS

FIG. 1 depicts a block diagram of a computing environment for implementing concepts and computer-based methods, according to at least one embodiment.

FIG. 2 depicts a flow diagram of a computer-implemented method for gamification of multi-factor authentication, according to at least one embodiment.

FIG. 3 depicts a flow diagram of a computer-implemented method for gamification of multi-factor authentication, according to at least one embodiment.

FIG. 4 depicts a flow diagram of a computer-implemented method for gamification of multi-factor authentication, according to at least one embodiment.

FIG. 5 depicts a block diagram of a computing system for gamification of multi-factor authentication, according to at least one embodiment.

FIG. 6 is a schematic diagram of a cloud computing environment in which concepts of the present disclosure may be implemented, in accordance with an embodiment of the present disclosure.

FIG. 7 is a diagram of model layers of a cloud computing environment in which concepts of the present disclosure may be implemented, in accordance with an embodiment of the present disclosure.

### DETAILED DESCRIPTION

The present disclosure relates generally to methods for multi-factor authentication. More particularly, but not exclusively, embodiments of the present disclosure relate to a computer-implemented method for gamification of multi-factor authentication. The present disclosure relates further to a related system for multi-factor authentication, and a computer program product for operating such a system.

Authentication processes may use one, two, or any number of identifying credentials to verify a user's identity for authorized access to a computing system, network, or device. In some systems, users are allowed to select between single factor authentication, two-factor authentication, and multi-factor authentication. Single factor authentication can be useful for relatively high usability and familiarity. However, single factor authentication may also be associated with relatively poorer security. For example, single factor authentication may be more vulnerable to certain vulnerabilities compared to two-factor authentication or multifactor authentication. These vulnerabilities may include phishing attacks, key loggers, stolen data due to data breaches, or easily guessed passwords in situations where users are not subject to password requirements or guidelines.

Two-factor authentication may use primary authentication credentials (e.g., passwords, pins, or PIV cards) and a second factor or token (e.g., one-time passwords, pin numbers, or system generated tokens). Two-factor authentication may improve security over single factor authentication. Although two-factor authentication improves security to many common vulnerabilities and attacks, adoption of two-factor authentication has been slow. Users often opt for single factor authentication when allowed to choose due to the moderately increased inconvenience of using a second factor in two-factor authentication.

Multi-factor authentication uses two or more independent factors to grant a user access to a system, network, or device. Multi-factor authentication may use identification credentials across differing categories of information. These categories are often referred to as “something you know,” “Something you have,” “Something you are,” and “Something you do.” The first category may include identification credentials such as passwords and pins. The second category may include identification credentials such as a token or possession of a device. The third category may include identification credentials such as fingerprints or facial feature identification. The fourth category may include identification credentials such as typing speed, location information, or other suitable activity credentials.

As additional factors are added to authentication systems or processes, users are less likely to adopt the new authentication process. As attacks and vulnerabilities increase of computer systems, stronger authentication is beneficial. Similarly, stronger authentication processes are beneficial as computer systems store increasing amounts of personal or sensitive information. With the benefits of stronger authentication systems and processes and the resistance of users to those systems and processes, there is a need to provide systems and methods to enable or encourage users to adopt stronger authentication systems and processes.

Augmented reality (AR) and virtual reality (VR) technologies are being adopted within various elements of industry. Industrial environments, such as manufacturing and production of goods, are currently adopting AR/VR systems to perform activities with various types of machinery and production systems. Industrial adoption of AR and VR systems enables workers to train and properly perform a variety of job-related functions. For example, activities such as assembly, disassembly, metal cutting, operating machines, working machine shop floors, mining activities, and the like may be performed using AR or VR systems. Using AR and VR systems, users may perform actions in a guided manner while maintaining physical access to and awareness of their surroundings. Authentication processes in differing areas of industry may vary in complexity and available input devices. Further, authentication processes in some areas of industry include differing availability of physical access to computing systems. In some areas of industry, physical authentication may be prioritized to validate workers in using various types of equipment in specified physical surroundings. Industrial application of authentication processes, involving differing types of machines, input devices, and physical access requirements, often add resistance to user adoption of multi-factor authentication.

Embodiments of the present disclosure provide systems and methods to increase adoption of stronger authentication processes and systems. Some embodiments of the present disclosure enable virtual reality-based system for user authentication. The virtual reality-based system dynamically creates a virtual environment for collection of authentication or identification credentials in a user-friendly manner. Some embodiments of the present disclosure enable gamification of the authentication process. The present disclosure enables dynamic creation of a gamification story or narrative framework to engage users in authentication processes. Some embodiments of the present disclosure dynamically generate or modify a gamification story or narrative framework based on available input devices and identification or authentication credentials available to a computing system, computing device, or computing network. Embodiments of the present disclosure enable collection of authentication or identification credentials during presentation of a gamification story or narrative framework and identify or authorize a user based on the collected credentials.

Some embodiments of the concepts described herein may take the form of a system or a computer program product. For example, a computer program product may store program instructions that, when executed by one or more processors of a computing system, cause the computing system to perform operations described above with respect to the computer-implemented method. By way of further example, the system may comprise components, such as processors and computer-readable storage media. The computer-readable storage media may interact with other components of the system to cause the system to execute program instructions comprising operations of the computer-implemented method, described herein. For the purpose of this description, a computer-usable or computer-readable medium may be any apparatus that may contain means for storing, communicating, propagating, or transporting the program for use, by, or in connection with, the instruction execution system, apparatus, or device.

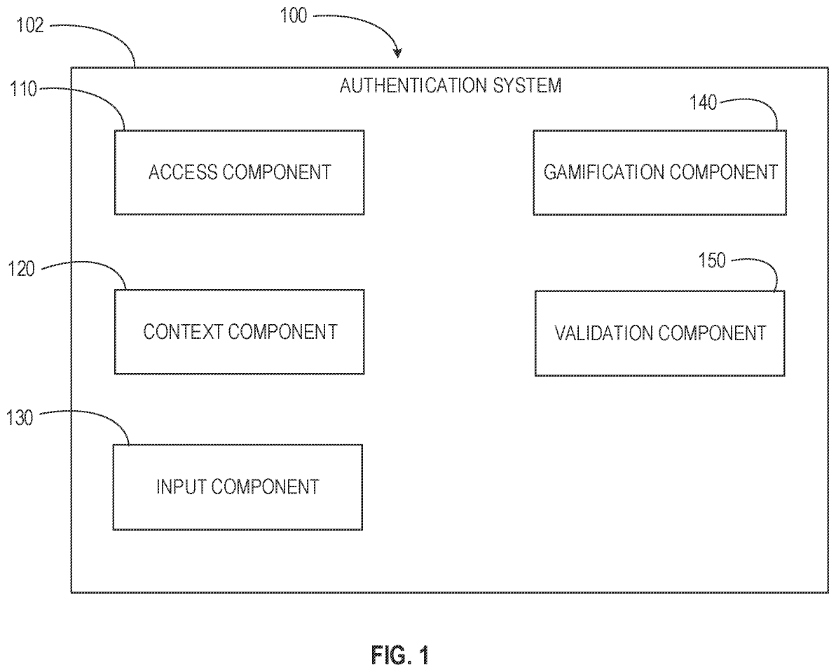

Referring now to FIG. 1, a block diagram of an example computing environment 100 is shown. The present disclosure may be implemented within the example computing environment 100. In some embodiments, the computing environment 100 may be included within or embodied by a computer system, described below. The computing environment 100 may include an authentication system 102. The authentication system 102 may comprise an access component 110, a context component 120, an input component 130, a gamification component 140, and a validation component 150. The access component 110 receives authentication requests from users or computing devices accessible by a user. The context component 120 identifies an application context for a received authentication request. The input component 130 identifies input devices associated with an authentication system responding to an authentication request and generates sets of user interaction prompts. The gamification component 140 presents user interaction prompts within an audio-visual environment and generates gamification story or narrative framework to present user interaction prompts. The validation component 150 authenticates users based on authentication credentials collected during presentation of user interaction prompts in the audio-visual environment. Although described with distinct components, it should be understood that, in at least some embodiments, components may be combined or divided, and/or additional components may be added without departing from the scope of the present disclosure.

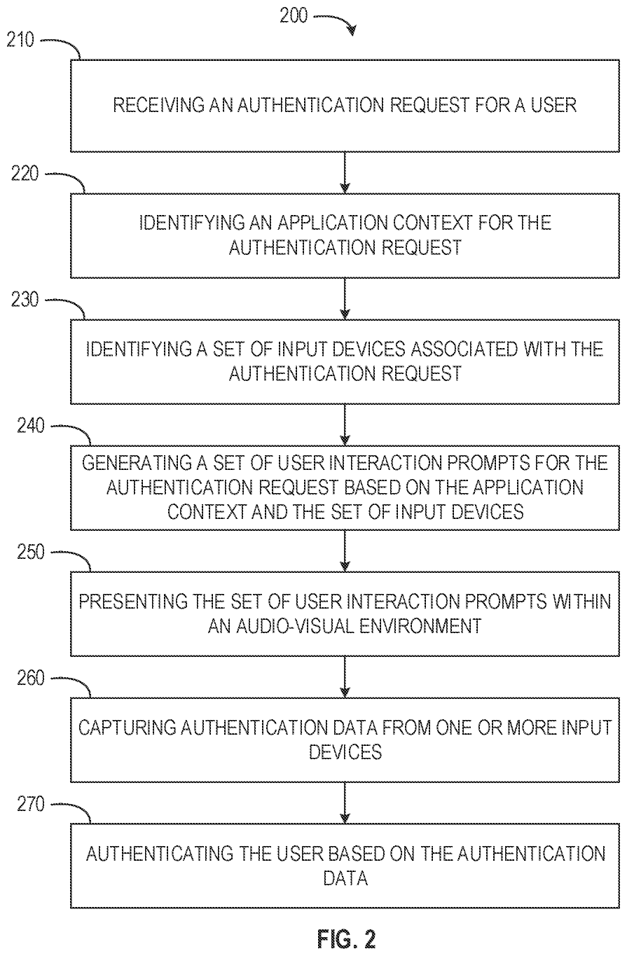

Referring now to FIG. 2, a flow diagram of a computer-implemented method 200 is shown. The computer-implemented method 200 is a method for gamification of multi-factor authentication. In some embodiments, the computer-implemented method 200 may be performed by one or more components of the computing environment 100, as described in more detail below.

At operation 210, the access component 110 receives an authentication request for a user. The access component 110 may receive authentication requests from computing devices accessible by the user. In some embodiments, authentication requests are generated at a computing device, such as a mobile computing device, a laptop, a desktop computer, or a network computing resource. For example, a user may access a computing device and select a user interface element to log into the computing device or a network resource accessible by the computing device. Selection of the user interface element, such as a log in button, may generate the authentication request. Once generated, the authentication request may be passed to the access component 110. In some instances, the access component 110 cooperates with the input component 130 to directly receive the access request based on user interaction with the computing device.

At operation 220, the context component 120 identifies an application context for the authentication request. The application context may define a type of authentication request, a type of computing device or computing resource to be accessed based on the authentication request, or a type of application to be accessed based on the authentication request. The application context may also define a type of authentication to be applied based on one or more of the authentication request, the type of computing device or resource to be accessed, the type of application to be accessed, and an operating environment of the computing device or application. In some instances, the application context includes identifying whether a user is requesting physical access to a computing resource, logical access to a computing resource, access to an application, or any other computer related activities. In identifying the application context, the context component 120 may determine a type of authentication mode to deploy. The authentication modes may include single factor authentication, two-factor authentication, or multi-factor authentication.

In some embodiments, the multi-factor authentication mode includes a set of authentication modes. The set of authentication modes may correspond to a number of factors to be applied during the multi-factor authentication process. In such instances, the subset of authentication modes may include two-factor authentication, three-factor authentication, four-factor authentication, or any suitable number of authentication credentials. In identifying the application context and selecting multi-factor authentication, the context component 120 may determine an authentication mode selected from the set of authentication modes of the multi-factor authentication.

In some instances, the application context identifies the application context based on a security status of an application, device, or resource to accessed (subject to the authentication request). For example, the context component 120 may identify an application to access and a security status for the application. The security status may be associated with one or more security rules for the application. The context component 120 may determine the security rules for the identified application indicate multi-factor authentication using three or more identification credentials or factors.

At operation 230, the input component 130 identifies a set of input devices associated with the authentication request. In some embodiments, the set of input devices include an audio-visual environment device. The audio-visual environment device may be an augmented reality device or a virtual reality device. The set of input devices may also include image capture devices, audio capture devices, biometric input devices, keyboards, combinations thereof, or any other suitable device capable of sensing or receiving user input. Image capture devices may include cameras, retina scanning devices, imaging devices, two-dimensional imaging devices, three-dimensional, ultrasound scanning devices, or other suitable imaging devices. Audio capture devices may include microphones, video cameras, ultrasound devices, voice recognition systems or functionality, or any other suitable audio capture devices. Biometric input devices may include retina scanners, heart rate sensors, fingerprint scanners or fingerprint readers, facial recognition systems, facial recognition functionality, gait recognition systems or functionality, combinations thereof, or any other suitable biometric input devices. The input component 130 may identify the set of input devices as input devices associated with a computing device from which the authentication request was received. In some instances, the input component 130 identifies the set of input devices associated with the authentication request.

The input component 130 may receive an input indication from the access component 110 in response to the authentication request. The input component 130 may detect or poll available input devices connected to, in communication with, or accessible by the authentication system 102. For example, the input component 130 may receive an indication of an authentication request originating from a desktop workstation. The input component 130 may identify a mouse, a keyboard, a camera, and a fingerprint reader as the set of input devices associated with the desktop workstation and the authentication request received from the desktop workstation.

At operation 240, the input component 130 generates a set of user interaction prompts for the authentication request. In some embodiments, the set of user interaction prompts are generated based on the application context and the set of input devices. The set of user interaction prompts may correspond to one or more user interactions with one or more input devices. In some embodiments, the set of user interaction prompts cause a user to perform appropriate physical gestures with appropriate postures to complete authentication. In some instances, external systems, such as ultrasound modules or imaging devices, may capture the user performing the physical gestures and posture to gather authentication data.

In some embodiments, a number of user interaction prompts for the set of user interaction prompts may be selected based on the application context. For example, where multi-factor authentication is selected as an authentication mode using three authentication credentials, the input component 130 may generate a set of user interaction prompts including three user interaction prompts. Each user interaction prompt of the set of user interaction prompts may employ a different input device. For example, where the set of user interaction prompts includes three user interaction prompts and the set of input devices includes in a camera, a microphone, a keyboard, a heart rate sensor, and an ultrasonic sensor, the input component 130 may generate the set of user interaction prompts as having three user interaction prompts with each user interaction prompt using a different input device. In some instances, the three user interaction prompts use a subset of input devices in with distinct input types. For example, the input component 130 may identify a camera as a user input device and generate two user interaction prompts using the camera, such as a face identification, a fingerprint identification, a gait recognition, or a retina scan.

In some embodiments, the set of user interaction prompts includes a first user interaction prompt and a second user interaction prompt. The first user interaction prompt may be for a first input device. For example, the first user interaction prompt may prompt a user to walk and the first input device, a camera, may capture authentication data of the user walking for gait recognition and authentication. The second user interaction prompt may be for a second input device. In some instances, the first user interaction prompt and the second user interaction prompt use a common input device with different input types. For example, the second user interaction prompt may prompt a user to catch a ball or grip a handle and the second input device, an ultrasound scanning system, may track a fingerprint of the user at distance.

At operation 250, the gamification component 140 presents the set of user interaction prompts within an audio-visual environment. In some embodiments, the audio-visual environment is an augmented reality system. In some instances, the audio-visual environment is a virtual reality system. The gamification component 140 may present the set of user interaction prompts in an augmented reality environment or a virtual reality environment (e.g., the audio-visual environment) using the audio-visual environment device (e.g., an augmented reality device or a virtual reality device).

Where the set of user interaction prompts includes the first user interaction prompt and the second user interaction prompt, the gamification component 140 presents the first user interaction prompt within the audio-visual environment. The gamification component 140 may also present the second user interaction prompt within the audio-visual environment.

The gamification component 140 may present the set of user interaction prompts in the audio-visual environment in a gaming or gamification context. The gaming or gamification context may be a narrative framework or story-based gaming context. In some instances, the set of user interaction prompts are generated to correspond to activities or elements within the narrative of the gaming context. Where the set of user interaction prompts are presented within a gaming or gamification context, the set of user interaction prompts may represent activities to be performed in the gaming or gamification context. The activities may be associated with elements or objectives presented in the narrative framework or story.

In some embodiments, the gaming context, narrative framework, or story may be tailored or configured based on the user requesting authentication. The narrative framework, generated for the set of user interaction prompts, may be generated by an artificial intelligence enabled story creation module. The story may be simulated in a virtual reality or augmented reality environment for authentication of the user within the gaming or gamification context.

At operation 260, the input component 130 captures authentication data from the one or more input devices during presentation of the set of user interaction prompts. The authentication data may be captured by one or more input devices of the set of input devices identified in operation 230. The authentication data may be captured by the one or more input devices based on user interaction with the one or more input devices. Capture of the authentication data may be performed in response to presentation of one or more user interaction prompts of the set of user interaction prompts. For example, the input component 130 may collect at least two or more of audio segments for voice recognition, ultrasonic scan data, image data, retina scan data, fingerprint data, fingerprint data from a distance, heart rate data, gait data, a password, or a token from user interactions responding to user interaction prompts. The input component 130 may capture the authentication data, responsive to user interaction prompts, as the gamification component 140 presents the set of user interaction prompts within the audio-visual environment. In some instances, the input component 130 captures the authentication data as the set of user interaction prompts are presented within a narrative framework, story, or gamification of the authentication process.

Where the set of user interaction prompts includes the first user interaction prompt and the second user interaction prompt, the input component 130 may capture authentication data for the first user interaction prompt from the first input device. The input component 130 may capture authentication data for the second user interaction prompt from the second input device.

At operation 270, the validation component 150 authenticates the user based on the authentication data. In some embodiments, the validation component 150 may access stored authentication credentials which were previously provided for the user or captured for the user. The validation component 150 may compare captured authentication data corresponding to each user interaction prompt to stored authentication credentials of the user. Where the captured authentication data matches the stored authentication credentials, the validation component 150 determines the user is authenticated and issues an access grant for a use session for a specified computing device, computing system, computing resource, application, or machine. Upon issuing the access grant, the user may receive access to the relevant machine, application, or resource for which authentication and access were requested.

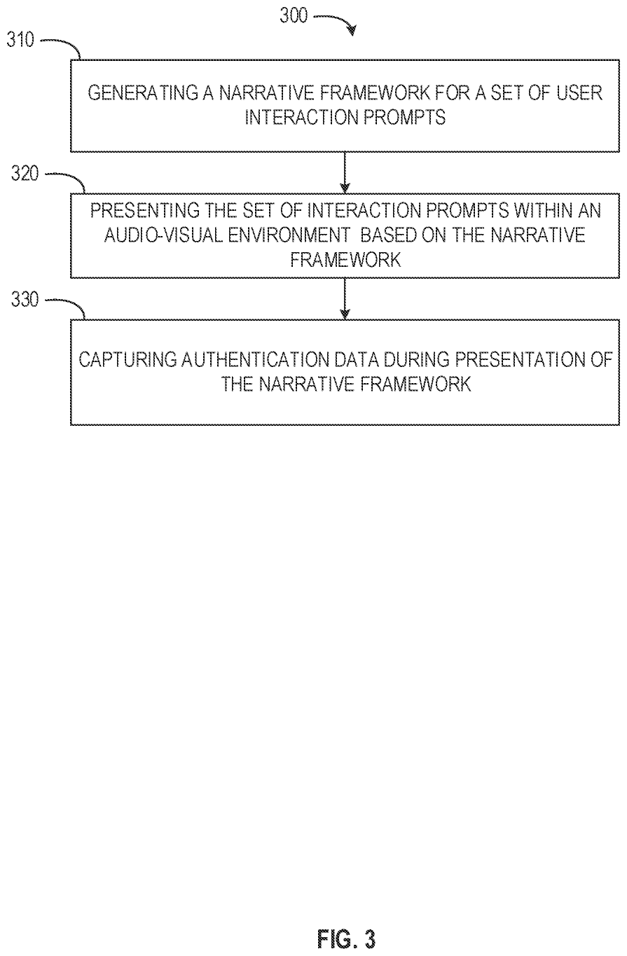

FIG. 3 shows a flow diagram of an embodiment of a computer-implemented method 300 for gamification of multi-factor authentication. The method 300 may be performed by or within the computing environment 100. In some embodiments, the method 300 comprises or incorporates one or more operations of the method 200. In some instances, operations of the method 300 may be incorporated as part of sub-operations of the method 200.

In operation 310, the gamification component 140 generates a narrative framework for the set of user interaction prompts. In some embodiments, the narrative framework can be unique to each user requesting authentication. The narrative framework may include a story generated to gamify the authentication process. The narrative framework may be generated with audio-visual navigation elements, such that a user within an audio-visual environment (e.g., AR or VR environment) may interact with a story and perform actions associated with the story to remotely control or provide input to a computing device or system as part of the authentication process.

The narrative framework may be generated based on the set of user interaction prompts, a set of input devices available, the user requesting authentication, a physical environment of the user, a device from which the authentication request was received, or combinations thereof. The gamification component 140 may dynamically generate a narrative framework within an audio-visual environment (e.g., VR or AR environment) based on actions of a user, input devices available to a user, an application context, or an authentication mode.

In some embodiments, the gamification component 140 generates a narrative framework for the set of user interaction prompts based on the user seeking to be authenticated. In such embodiments, the user may be prompted to provide a first identification credential. Once the first identification credential is provided, the gamification component 140 may generate the narrative framework based on preferences provided by the user. In some instances, the gamification component 140 stores interactions by the user during each gamification-based authentication session. Each gamification-based authentication session may correspond to the user entering the audio-visual environment, performing interactions in response to user interaction prompts, and being successfully authenticated. In some instances, the interactions performed by the user may include correctly performed interactions and incorrectly performed interactions. The incorrectly performed interactions may indicate interactions which the user failed to perform, were not detectable when the user interacted with an input device, interactions associated with malfunctioning or disconnected input devices, or other suitable actions which did not provide authentication data. The correctly performed interactions and incorrectly performed interactions may be logged. The logged interactions may be incorporated into a profile for the user. The profile for the user may include user preferences for interaction types, input types, input devices, security levels, or any other information a user may provide relating to authentication processes. The logged interactions and user preferences may be maintained in a secured manner to prevent identifying information of a user from being inappropriately accessed.

In some embodiments, user preferences, correctly performed interactions, and incorrectly performed interaction data may be sanitized to remove identifying information. The sanitized interaction and preference data for a group of users requesting authentication may be used to weight generation of one or more of the narrative framework and the set of user interaction prompts for users. For example, user interaction prompts which have a relatively higher success rate (e.g., users performing the interaction successfully and the interaction resulting in high confidence authentication data) may be prioritized for inclusion in a narrative framework and a set of user interaction prompts for users across the group of users. By way of further example, a prioritized or weighted user interaction prompt may be precluded from presentation to selected users within the group of users, where the selected users are associated with a higher fail rate for that user interaction prompt or lack access to an input device suitable for that user interaction prompt.

In operation 320, the gamification component 140 presents the set of user interaction prompts within an audio-visual environment. The presentation of the set of user interaction prompts may be based on the narrative framework. For example, the gamification component 140 may present a user with a story in a VR environment which prompts the user to walk. The prompt to walk may be a user interaction prompt of the set of user interaction prompts. A non-player character requesting the user to walk or a circumstance prompting the user to walk may be a presentation of the user interaction prompt within the audio-visual environment.

In some embodiments, the gamification component 140 presents the set of user interaction prompts in an order corresponding to the narrative framework. The order may be generated for the narrative framework so that the narrative framework flows in a manner that the user recognizes. For example, the set of user interaction prompts may include four user interaction prompts (e.g., throw a ball, grip a ball, walk, and speak a catch phrase). The narrative framework may be a short story of returning a ball that was thrown over a fence. The set of user interaction prompts may be ordered such that the first user interaction prompt causes the user to say, “Is this your ball.” The second user interaction prompt causes the user to walk to a ball pictured on the ground. The third user interaction prompt causes the user to grip the ball. The fourth user interaction prompt causes the user to throw the ball.

In operation 330, the input component 130 captures authentication data during presentation of the narrative framework. The input component 130 may capture the authentication data using a set of input devices corresponding to input types of the set of user interaction prompts. For example, the input component 130 may capture the catch phrase with a microphone, the walk and throw of the ball with a camera, and the grip of the ball with an ultrasound module. In some embodiments, operation 330 may be performed in a manner similar to or the same as described above with respect to operation 260.

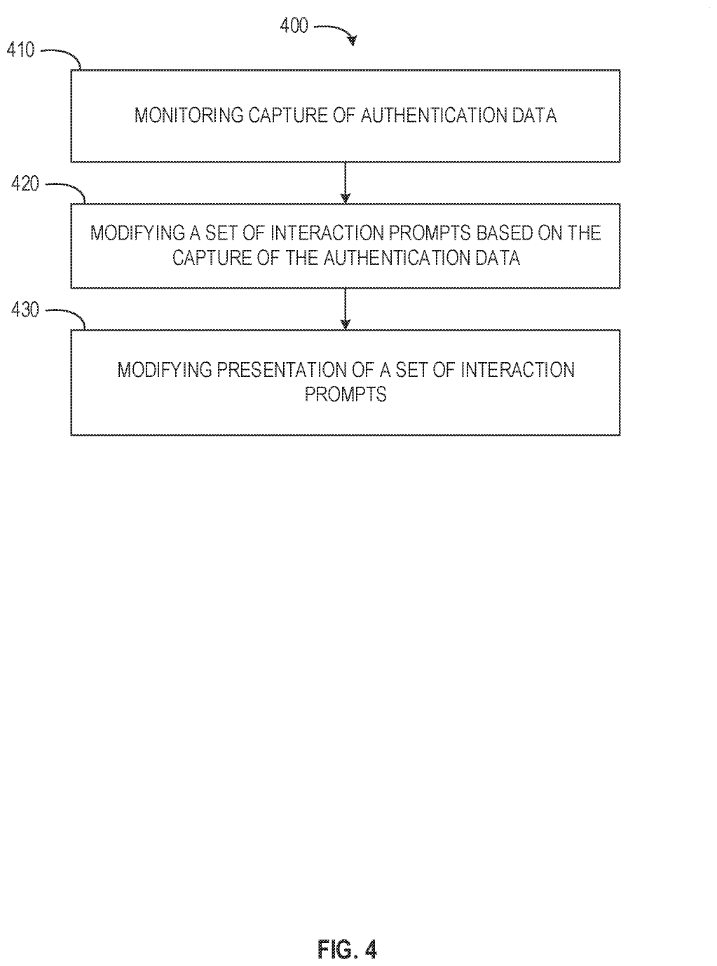

FIG. 4 shows a flow diagram of an embodiment of a computer-implemented method 400 for gamification of multi-factor authentication. The method 400 may be performed by or within the computing environment 100. In some embodiments, the method 400 comprises or incorporates one or more operations of the method 200. In some instances, operations of the method 400 may be incorporated as part of or sub-operations of the method 200.

In operation 410, the gamification component 140 monitors the capture of authentication data. The gamification component 140 may monitor the capture of authentication data in cooperation with the input component 130. The gamification component 140 may monitor the capture of authentication data in a manner similar to or the same as described above with respect to operations 250 and 260 or method 300.

In operation 420, the input component 130 modifies the set of user interaction prompts. The set of user interaction prompts may be modified based on the capture of authentication data. In some embodiments, the input component 130 modifies the set of user interaction prompts within a gamification, gaming environment, or narrative framework within the audio-visual environment. The input component 130 may modify the set of user interaction prompts as part of a change to the gamification, gaming environment, or narrative framework.

In some embodiments, the gamification component 140 identifies user interactions with input devices in response to user interaction prompts. Where the gamification component 140 identifies an incorrect action of the user, the gamification component 140 may modify the set of user interaction prompts by generating a subsequent user interaction prompt. The subsequent user interaction prompt may correct the incorrect action of the user, provide a second opportunity to perform the same interaction, provide a prompt for a new interaction type, or provide a prompt for a new input type. In some instances, the subsequent interaction is an interaction having a same level of security as the user interaction prompt associated with the incorrect action.

The subsequent user interaction prompt may be the same interaction type or input type as the user interaction prompt for which the user performed the incorrect action. For example, where the incorrect action failed to properly perform a retina scan based on a first user interaction prompt, the gamification component 140 may generate a second user interaction prompt, using the same interaction type, for a retina scan and append the second user interaction prompt to the set of user interaction prompts. By way of further example, where the incorrect action failed to properly perform a retina scan based on a first user interaction prompt, the gamification component 140 may generate a second user interaction prompt, using a same input type, for a facial identification scan as a second user interaction prompt. In this example, using an available camera, the gamification component 140 may generate the facial scan user interaction prompt as an interaction having the same input type (e.g., camera input) as the retina scan. In some instances, the gamification component 140 may generate the subsequent user interaction prompt using the same input type after determining the incorrect action may not be corrected using a subsequent user interaction prompt using the same interaction type.

In operation 430, the gamification component 140 modifies presentation of a set of user interaction prompts. In some embodiments, the gamification component 140 modifies the presentation of user interaction prompts by modifying the narrative framework. Modification of the set of user interaction prompts, the narrative framework, or combinations thereof may be based on the capture of the authentication data.

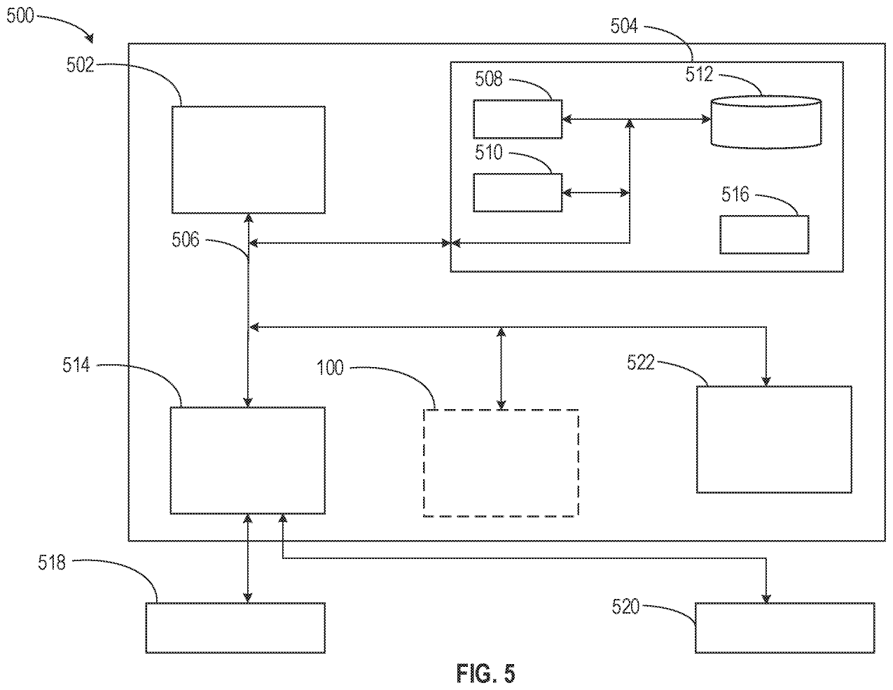

Embodiments of the present disclosure may be implemented together with virtually any type of computer, regardless of the platform is suitable for storing and/or executing program code. FIG. 5 shows, as an example, a computing system 500 (e.g., cloud computing system) suitable for executing program code related to the methods disclosed herein and for gamification of multi-factor authentication.

The computing system 500 is only one example of a suitable computer system and is not intended to suggest any limitation as to the scope of use or functionality of embodiments of the present disclosure described herein, regardless, whether the computer system 500 is capable of being implemented and/or performing any of the functionality set forth hereinabove. In the computer system 500, there are components, which are operational with numerous other general-purpose or special purpose computing system environments or configurations. Examples of well-known computing systems, environments, and/or configurations that may be suitable for use with computer system/server 500 include, but are not limited to, personal computer systems, server computer systems, thin clients, thick clients, hand-held or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like. Computer system/server 500 may be described in the general context of computer system-executable instructions, such as program modules, being executed by a computer system 500. Generally, program modules may include routines, programs, objects, components, logic, data structures, and so on that perform particular tasks or implement particular abstract data types. Computer system/server 500 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 500 is shown in the form of a general-purpose computing device. The components of computer system/server 500 may include, but are not limited to, one or more processors 502 (e.g., processing units), a system memory 504 (e.g., a computer-readable storage medium coupled to the one or more processors), and a bus 506 that couple various system components including system memory 504 to the processor 502. Bus 506 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 500 typically includes a variety of computer system readable media. Such media may be any available media that is accessible by computer system/server 500, and it includes both, volatile and non-volatile media, removable and non-removable media.

The system memory 504 may include computer system readable media in the form of volatile memory, such as random-access memory (RAM) 508 and/or cache memory 510. Computer system/server 500 may further include other removable/non-removable, volatile/non-volatile computer system storage media. By way of example only, a storage system 512 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 506 by one or more data media interfaces. As will be further depicted and described below, the system memory 504 may include at least one program product having a set (e.g., at least one) of program modules that are configured to carry out the functions of embodiments of the present disclosure.

The program/utility, having a set (at least one) of program modules 516, may be stored in the system memory 504 by way of example, and not limiting, as well as an operating system, one or more application programs, other program modules, and program data. Program modules may include one or more of the access component 110, the context component 120, the input component 130, the gamification component 140, and the validation component 150, which are illustrated in FIG. 1. Each of the operating systems, one or more application programs, other program modules, and program data or some combination thereof, may include an implementation of a networking environment. Program modules 516 generally carry out the functions and/or methodologies of embodiments of the present disclosure, as described herein.

The computer system/server 500 may also communicate with one or more external devices 518 such as a keyboard, a pointing device, a display 520, etc.; one or more devices that enable a user to interact with computer system/server 500; and/or any devices (e.g., network card, modem, etc.) that enable computer system/server 500 to communicate with one or more other computing devices. Such communication can occur via Input/Output (I/O) interfaces 514. Still yet, computer system/server 500 may communicate with one or more networks such as a local area network (LAN), a general wide area network (WAN), and/or a public network (e.g., the Internet) via network adapter 522. As depicted, network adapter 522 may communicate with the other components of computer system/server 500 via bus 506. It should be understood that, although not shown, other hardware and/or software components could be used in conjunction with computer system/server 500. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models may include private cloud, community cloud, public cloud, and hybrid cloud. In private cloud, the cloud infrastructure is operated solely for an organization. It may be managed by the organization or a third party and may exist on-premises or off-premises. In community cloud, the cloud infrastructure is shared by several organizations and supports specific community that has shared concerns (e.g., mission, security requirements, policy, and compliance considerations). It may be managed by the organizations or a third party that may exist on-premises or off-premises. In public cloud, the cloud infrastructure is made available to the general public or a large industry group and is owned by an organization selling cloud services. In hybrid cloud, the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling modularity, and semantic interoperability. At the heart of cloud computing is an infrastructure that includes a network of interconnected nodes.

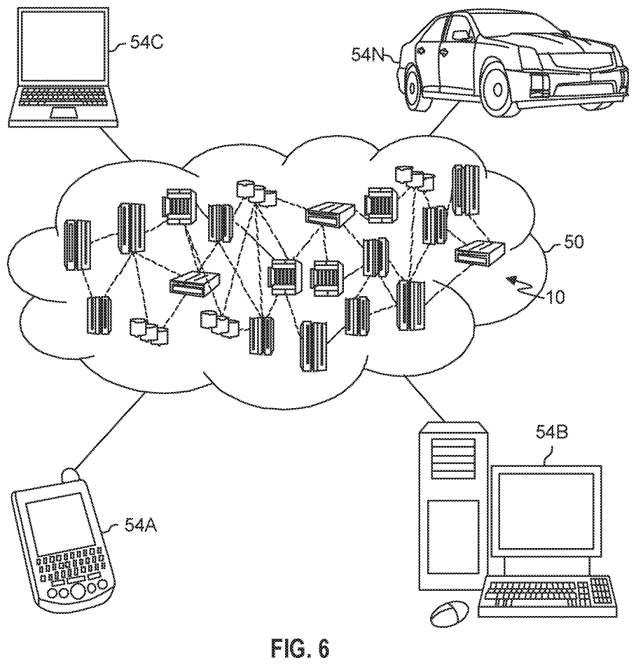

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

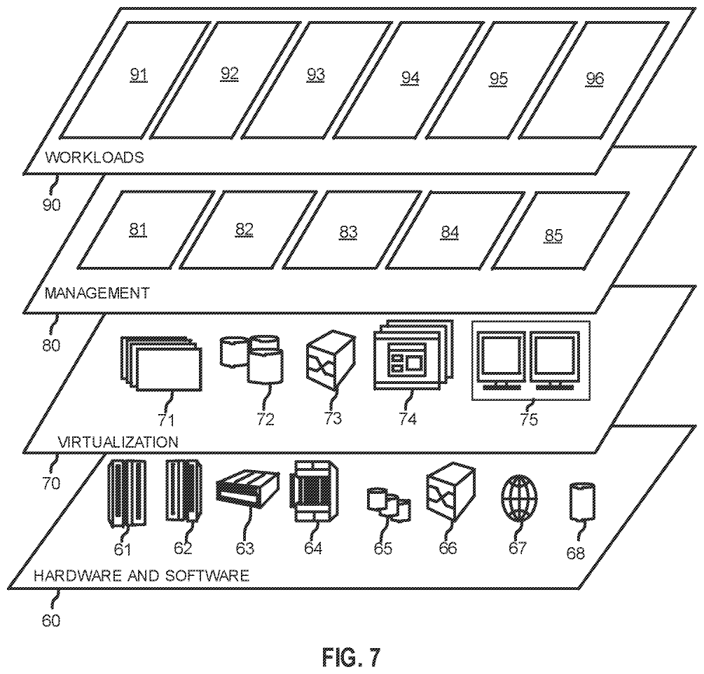

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and gamified authentication processing 96.

Cloud models may include characteristics including on-demand self-service, broad network access, resource pooling, rapid elasticity, and measured service. In on-demand self-service a cloud consumer may unilaterally provision computing capabilities such as server time and network storage, as needed automatically without requiring human interaction with the service's provider. In broad network access, capabilities are available over a network and accessed through standard mechanisms that promote use by heterogeneous thin or thick client platforms (e.g., mobile phones, laptops, and PDAs). In resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In rapid elasticity, capabilities can be rapidly and elastically provisioned, in some cases automatically, to quickly scale out and rapidly released to quickly scale in. To the consumer, the capabilities available for provisioning often appear to be unlimited and can be purchased in any quantity at any time. In measured service, cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

The descriptions of the various embodiments of the present disclosure have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer-readable storage medium (or media) having computer readable program instructions thereon for causing a processor to carry out aspects of the present invention.

The computer-readable storage medium may be an electronic, magnetic, optical, electromagnetic, infrared or a semi-conductor system for a propagation medium. Examples of a computer-readable medium may include a semi-conductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description, but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, at an authentication system, an authentication request for a user;
identifying an application context for the authentication request;
identifying a set of input devices associated with the authentication system;
based on the application context and the set of input devices, generating a set of user interaction prompts for the authentication request, the set of user interaction prompts corresponding to one or more user interactions with one or more input devices;
presenting the set of user interaction prompts within an audio-visual environment;
capturing authentication data from the one or more input devices during presentation of the set of user interaction prompts; and
authenticating the user based on the authentication data.

2. The method of claim 1, wherein generating the set of user interaction prompts includes a first user interaction prompt for a first input device and a second user interaction prompt for a second input device, and wherein presenting the set of user interaction prompts further comprises:
presenting the first user interaction prompt within the audio-visual environment;
capturing first authentication data from the first input device;
presenting the second user interaction prompt within the audio-visual environment; and
capturing second authentication data from the second input device.

3. The method of claim 1, wherein the audio-visual environment is an augmented reality system.

4. The method of claim 1, wherein the audio-visual environment is a virtual reality system.

5. The method of claim 1, further comprising:
generating a narrative framework for the set of user interaction prompts;
presenting the set of user interaction prompts within the audio-visual environment based on the narrative framework; and
capturing the authentication data during presentation of the narrative framework.

6. The method of claim 5, further comprising:
monitoring the capture of the authentication data; and
based on the capture of the authentication data, modifying the narrative framework.

7. The method of claim 6, further comprising:
modifying the set of user interaction prompts based on the capture of the authentication data.

8. A system, comprising:
one or more processors; and
a computer-readable storage medium, coupled to the one or more processors, storing program instructions that, when executed by the one or more processors, cause the one or more processors to perform operations comprising:
receiving, at an authentication system, an authentication request for a user;
identifying an application context for the authentication request;
identifying a set of input devices associated with the authentication system;
based on the application context and the set of input devices, generating a set of user interaction prompts for the authentication request, the set of user interaction prompts corresponding to one or more user interactions with one or more input devices;
presenting the set of user interaction prompts within an audio-visual environment;
capturing authentication data from the one or more input devices during presentation of the set of user interaction prompts; and
authenticating the user based on the authentication data.

9. The system of claim 8, wherein generating the set of user interaction prompts includes a first user interaction prompt for a first input device and a second user interaction prompt for a second input device, and wherein presenting the set of user interaction prompts further comprises:
presenting the first user interaction prompt within the audio-visual environment;
capturing first authentication data from the first input device;
presenting the second user interaction prompt within the audio-visual environment; and
capturing second authentication data from the second input device.

10. The system of claim 8, wherein the audio-visual environment is an augmented reality system.

11. The system of claim 8, wherein the audio-visual environment is a virtual reality system.

12. The system of claim 8, wherein the operations further comprise:
generating a narrative framework for the set of user interaction prompts;
presenting the set of user interaction prompts within the audio-visual environment based on the narrative framework; and
capturing the authentication data during presentation of the narrative framework.

13. The system of claim 12, wherein the operations further comprise:
monitoring the capture of the authentication data; and
based on the capture of the authentication data, modifying the narrative framework.

14. The system of claim 13, wherein the operations further comprise:
modifying the set of user interaction prompts based on the capture of the authentication data.

15. A computer program product comprising a computer readable storage medium having program instructions embodied therewith, the program instructions being executable by one or more processors to cause the one or more processors to perform operations comprising:
receiving, at an authentication system, an authentication request for a user;
identifying an application context for the authentication request;
identifying a set of input devices associated with the authentication system;
based on the application context and the set of input devices, generating a set of user interaction prompts for the authentication request, the set of user interaction prompts corresponding to one or more user interactions with one or more input devices;
presenting the set of user interaction prompts within an audio-visual environment;
capturing authentication data from the one or more input devices during presentation of the set of user interaction prompts; and
authenticating the user based on the authentication data.

16. The computer program product of claim 15, wherein generating the set of user interaction prompts includes a first user interaction prompt for a first input device and a second user interaction prompt for a second input device, and wherein presenting the set of user interaction prompts further comprises:
presenting the first user interaction prompt within the audio-visual environment;
capturing first authentication data from the first input device;
presenting the second user interaction prompt within the audio-visual environment; and
capturing second authentication data from the second input device.

17. The computer program product of claim 15, wherein the audio-visual environment is an augmented reality system.

18. The computer program product of claim 15, wherein the audio-visual environment is a virtual reality system.

19. The computer program product of claim 15, wherein the operations further comprise:
generating a narrative framework for the set of user interaction prompts;
presenting the set of user interaction prompts within the audio-visual environment based on the narrative framework; and
capturing the authentication data during presentation of the narrative framework.

20. The computer program product of claim 19, wherein the operations further comprise:
monitoring the capture of the authentication data;
modifying the set of user interaction prompts based on the capture of the authentication data; and
based on the capture of the authentication data, modifying the narrative framework.
